(19) United States
(12) Patent Application Publication
(10) Pub. No.: US 2019/0381957 A1
(43) Pub. Date: Dec. 19, 2019

(54) Electronic License Plate and Method of Use Thereof

(71) Applicant: Vizrom Inc, Birmingham, AL (US)

(72) Inventor: Emmanuel Umoh, Pelham, AL (US)

(21) Appl. No.: 16/446,615

(22) Filed: Jun. 19, 2019

Related U.S. Application Data
(63) Continuation-in-part of application No. 29/656,552, filed on Jul. 13, 2018.
(60) Provisional application No. 62/687,082, filed on Jun. 19, 2018.

(51) Int. Cl. B60R 13/10; G09F 9/30; G09F 21/04; B60R 25/104; B60R 25/102; H04W 4/029; H04W 4/44; G06Q 20/32

(52) U.S. Cl. CPC B60R 13/105; G09F 9/30; G09F 21/048; B60R 25/104; B60Q 1/503; H04W 4/029; H04W 4/44; G06Q 20/32; B60R 25/102

(57) ABSTRACT

An electronic license plate has a digital display covered by a protective glass layer, positioned in a display frame, and electronically connected to a motherboard. A wireless communication device enables control of the contents of the digital display through cellular networks or other wireless communication means. A method of use of the electronic license plate enables displaying and updating relevant license plate information, in addition to GPS tracking, toll payment and parking payment features.

The current application claims a priority to the U.S. Provisional Patent application Ser. No. 62/687,082 filed on Jun. 19, 2018.

### FIELD OF THE INVENTION

The present invention relates generally to motor vehicles. More particularly, the present invention relates to an electronic license plate for motor vehicles.

### BACKGROUND OF THE INVENTION

For many years, a motor vehicle license plate has been metal or plastic with a registration number stamped on the front surface of the license plate. Two stickers are affixed on the plate, one on the top left-hand corner for the month, and the other on the top right-hand corner for the year when the government registration for the vehicle expires. When the vehicle is due for renewal, the owner of the vehicle has to go to the local office of the department of motor vehicles (DMV) or online to renew the registration. The new stickers will arrive through mail after the successful renewal registration. These stickers will then be affixed on the license plate to replace the old ones. The stickers together with the license plate number are used by the law enforcement personnel to validate the registration of the vehicle. Sometimes the stickers can be stolen by simply peeling off from the license plate. Then the stickers can be sold to someone else or used on the thief's own vehicle without being discovered in a timely manner. Further, a stolen vehicle will not be identified until it is stopped for an unrelated traffic violation and found out to be stolen by the law enforcement personnel when the registration information is checked against the national license plate database.

The present invention is intended to transform the metal or plastic license plate to a digital system which eliminates the paper or plastic stickers and enables an efficient means for renewal of vehicle registration. Additionally, the present invention provides a means for the user and law enforcement personnel to efficiently locate and track the stolen vehicle for quick discovery and recovery. Furthermore, the present invention offers other beneficial features such as automatic highway toll payment, parking validation, emergency messages, weather updates, etc.

Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a top exploded view of the present invention in accordance with some embodiments of the present invention.

FIG. 2 is a bottom exploded view of the present invention in accordance with some embodiments of the present invention.

FIG. 3 is a front perspective view and a rear perspective view of the display frame in accordance with some embodiments of the present invention.

FIG. 4 is a front perspective view and a rear perspective view of the motherboard in accordance with some embodiments of the present invention.

FIG. 5 is a front perspective view and a rear perspective view of the mounting frame in accordance with some embodiments of the present invention.

FIG. 6 is an exemplary embodiment of license plate information displayed on the digital display.

FIG. 7 is an exemplary embodiment of expired license plate information displayed on the digital display.

FIG. 8 is an exemplary embodiment of the digital display showing a stolen vehicle message.

FIG. 9 is a diagram of electronic components in accordance with some embodiments of the present invention.

FIG. 10 is a stepwise flow diagram describing the general method of the present invention.

FIG. 11 is a stepwise flow diagram describing location of information regions on the digital display.

FIG. 12 is a stepwise flow diagram describing steps for displaying a specialized message.

FIG. 13 is a stepwise flow diagram describing steps for displaying an expired vehicle registration.

FIG. 14 is a stepwise flow diagram describing steps for displaying an updated vehicle registration.

FIG. 15 is a stepwise flow diagram describing steps for utilizing the GPS module.

FIG. 16 is a stepwise flow diagram describing steps for facilitating a toll payment.

FIG. 17 is a stepwise flow diagram describing steps for facilitating parking payment.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

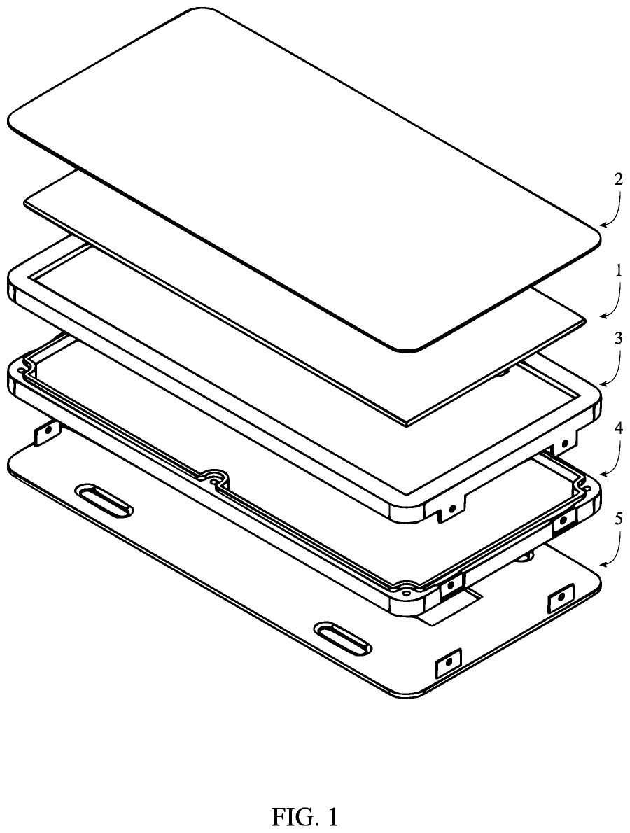

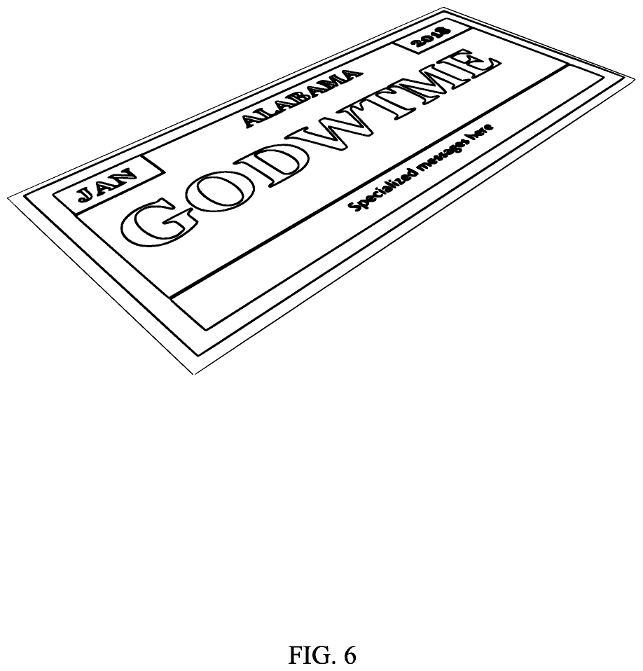

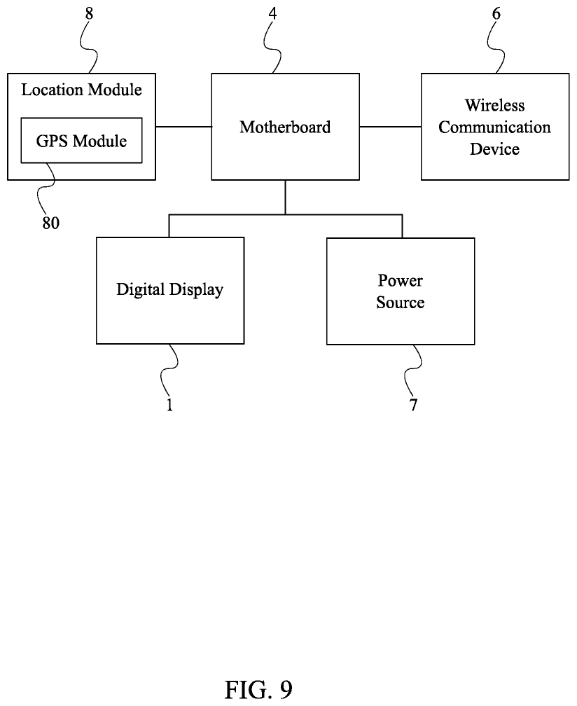

The present invention is an electronic license plate for motor vehicles and trailers. Referring to FIGS. 1-9, the preferred embodiment of the present invention comprises a digital display 1, a protective layer 2, a display frame 3, a motherboard 4, a mounting frame 5, a wireless communication device 6, and a power source 7.

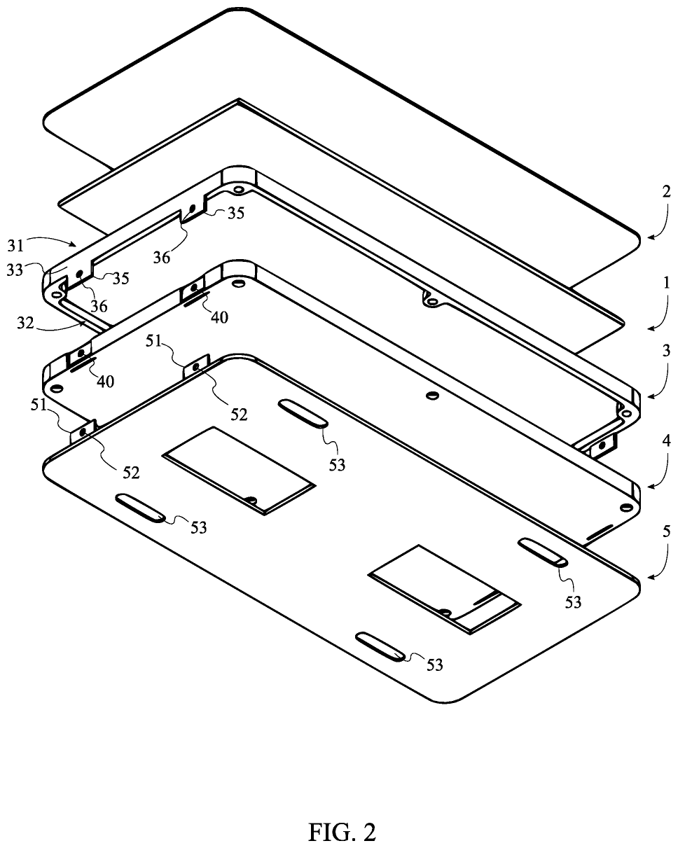

The protective layer 2, the digital display 1, the display frame 3, the motherboard 4, and the mounting frame 5 are all generally flat and planer in shape and are oriented parallel to each other, as seen in FIGS. 1-2. Furthermore, the protective layer 2, the digital display 1, the display frame 3, the motherboard 4, and the mounting frame 5 are assembled in series, being layered adjacent with each other. Components which are generally flat and planar in geometry and which are arranged so that their largest surfaces or planar volumes are positioned against each other, as with a stack of paper, may be said to be layered adjacent to each other, with each component forming one layer in a stack. More particularly, the digital display 1 is positioned between and layered adjacent to the protective layer 2 and the display frame 3. The display frame 3 is positioned between and layered adjacent to the digital display 1 and the motherboard 4, and the motherboard 4 is positioned between and layered adjacent to the display frame 3 and the mounting frame 5.

The motherboard 4 is electronically connected to the digital display 1 and the wireless communication device 6 in order to communicate amongst said components, and the power source 7 is electrically connected to the digital display 1 and the wireless communication device 6 in order to provide electrical power to said components. The power source 7 may vary in different embodiments. In some embodiments, the power source 7 may comprise a rechargeable built-in or removable battery. In some embodiments, the power source 7 may be a hard-wired connection to the electrical system of the motor vehicle the present invention is attached to. In some embodiments, detecting that the connection from the vehicle power to the battery is severed may be utilized as an indication that the present invention has been detached from the vehicle.

In the preferred embodiment of the present invention, the protective layer 2 is a protective glass layer, and is transparent. The protective layer 2 should be manufactured from a material that is transparent so that the digital display 1 is easily viewable, with sufficient strength and impact and scratch resistance to maintain its visual and structural integrity through any weather conditions and impacts such as rocks kicked up from the road by other vehicles. The protective layer 2 is affixed to the digital display 1, preferably through a bonding material such as optical adhesive or other suitable bonding materials. The protective layer 2 provides clear readability of the digital display 1 and protection of the digital display 1 from dust and other particles.

In the preferred embodiment, the digital display 1 is an electronic paper display (EPD). The digital display 1 functions to display any information relevant to or suitable for displaying on a license plate, and to easily change the information being displayed on demand or when certain conditions are met. It is contemplated that in various other embodiments, other types of digital displays may be utilized, such as, but not limited to, a liquid crystal displays (LCD), a light-emitting diode (LED) display, a plasma display panel (PDP), an organic LED (OLED) display, an electroluminescent display (ELD), or others. However, it is desirable to utilize an EPD as the digital display 1 in the preferred embodiment.

The electronic paper display (EPD) digitally displays information monochromatically. Thus, one of two colors may be the background color: black or white. Additionally, if the background is white, the text or other visual information displayed will be black, or vice versa. The digital display 1 further includes a flexible circuit connector on the back of the display, which can be attached to the motherboard 4 through a top slot opening of the display frame 3. The flexible circuit connector provides communication for the motherboard 4 to transmit digital information to be displayed on the digital display 1.

The EPD display is commonly referred to as “bi-stable”, which means that the image displayed on an EPD screen will be retained even after electrical power is removed. The EPD only consumes electrical power when the information on the screen changes. This feature of the EPD display significantly reduces power consumption and thus provides the whole device a long battery life. The display will consume a minimum amount of energy when there is any change of the display information but most the vehicle registration information normally does not change for a long period of time, such as one or more years. Only customized alert information that needs to be updated regularly may require a small amount of energy to display. Additionally, the larger the EPD screen, the more electrical power can be saved comparing with a traditional LCD screen of the same size. Further, the EPD does not include a back light thus will not emit light. Any ambient light will be reflected from the surface of the display. This feature of the EPD provides a print-like appearance and a high efficiency display even under direct sunlight.

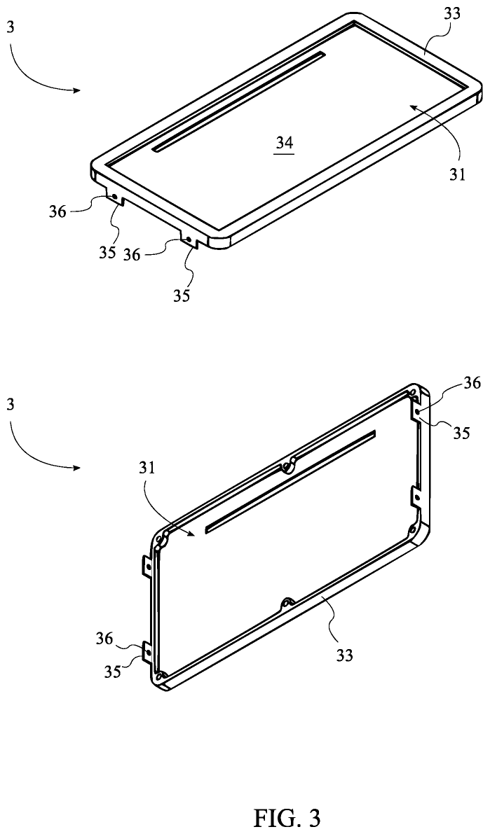

Referring to FIG. 3, the display frame 3 is a structural component configured to support the digital display 1 in its proper position. The display frame 3 may be manufactured of any desirable and useful material, such as, but not limited to, durable but lightweight plastic or metal. In the preferred embodiment, the display frame 3 comprises a front side 31, a back side 32, a perimeter 33 and a recess 34. The front side 31 and back side 32 are positioned opposite each other on the display frame 3. The perimeter 33 delineates the edges of the display frame 3, and the recess 34 is positioned within the perimeter 33, traversing into the front side 31 of the display frame 3. The digital display 1 is positioned within the recess 34. As previously mentioned, the display frame 3 further comprises a slot through which a flexible connector may pass in order to electronically connect the motherboard 4 to the digital display 1. The position of the slot on the display frame 3 may vary, but in the preferred embodiment, the slot is positioned adjacent to the perimeter 33 of the display frame 3.

The motherboard 4 is the electronic control and communication processing center of the present invention, comprising one or more computing devices such as, but not limited to, printed circuit boards (PCBs), microcontrollers, integrated circuits, resistors, capacitors, or any other electrical or electronic components suitable for achieving the purpose of the present invention. The motherboard 4 may further comprise structural elements in order to mount the motherboard 4 to the display frame 3 and the mounting frame 5. Other components which may be integrated onto the mother board may include, but are not limited to: one or more batteries, a global positioning system (GPS) module, a geolocation tracking device, one or more radio frequency (RF) receivers, transmitters, or sensors, and others. The motherboard 4 may be an open source device that can be purchased from a supplier or may be designed and custom made to the desired specification. The motherboard 4 communicates with an external server through the wireless communication device 6 and electronically transmits appropriate information to the EPD screen of the digital display 1 to displayed. In other embodiments, the motherboard 4 may take the form of any other configuration of electrical and/or electronic components necessary to facilitate the proper operation of the present invention.

In the preferred embodiment of the present invention, the motherboard 4 communicates through the wireless communication device 6 with one or more external electronic devices, servers, communication elements, or other relevant devices or elements in order to facilitate the desired operation of the present invention. It may be understood herein that the wireless communication device 6 may comprise one or more wireless communication devices, such as, but not limited to: one or more telecommunication antennas such as, but not limited to, 3G, 4G, LTE, or 5G antennas or other types of cellular network antennas, Bluetooth wireless communication devices, Wi-Fi antennas, near-field communication (NFC) devices, radio frequency identifier (RFID) devices, or other wireless communication devices. In addition, the preferred embodiment further comprises a location module 8 that is electronically connected to the motherboard 4. Moreover, in the preferred embodiment, the location module 8 is a global positioning system (GPS) module. The GPS module 80 allows the location of the present invention, and thus the user's vehicle, to be tracked in real time for various purposes.

In some alternate embodiments, the wireless communication device 6 may not be comprised, and instructions for displaying information on the digital display 1 may be received, or the present invention may otherwise be controlled by a physical electronic connection to the motherboard 4 from, for example, a smartphone, tablet, personal computer, universal serial bus (USB) storage drive, secure digital (SD) card, other non-volatile digital memory formats, or other relevant computing devices or data storage devices.

In the preferred embodiment of the present invention, the display frame 3 comprises a plurality of mounting brackets 35 and a plurality of holes 36. In the preferred embodiment, each of the plurality of mounting brackets 35 of the display frame 3 are laterally connected to a perimeter 33 of the display frame 3, and each of the plurality of holes 36 of the display frame 3 laterally traverse through one of the plurality of mounting brackets 35 of the display frame 3. Alternatively stated, each of the plurality of mounting brackets 35 of the display frame 3 is connected around the perimeter 33 of the display frame 3 and extend in a direction perpendicular to the display frame 3, while the plurality of holes 36 are oriented sideways.

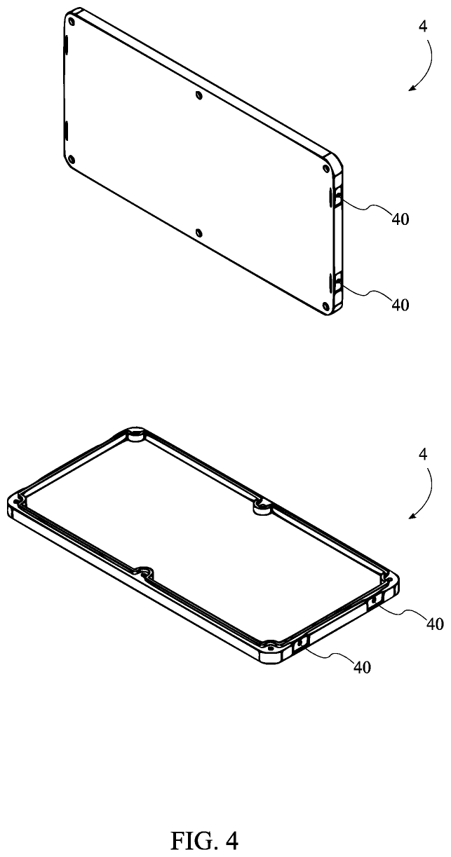

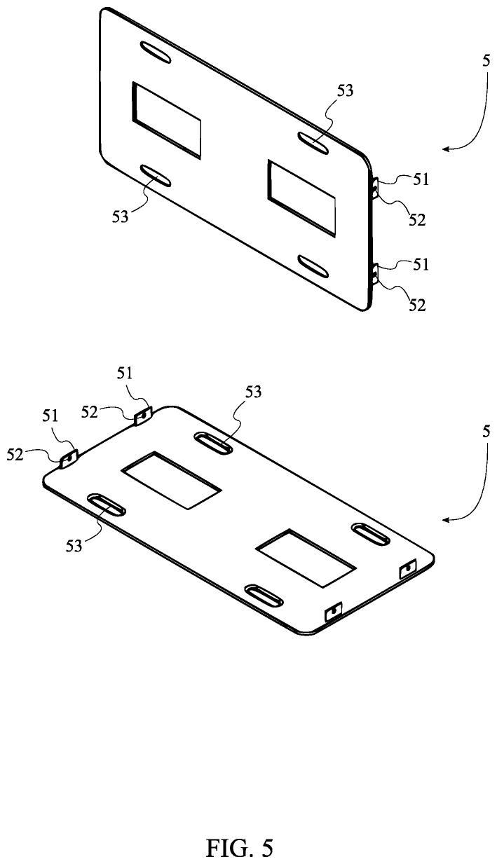

Further, referring to FIG. 4, the motherboard 4 comprises a plurality of threaded holes 40, with each of the plurality of threaded holes 40 traversing laterally into the motherboard 4, or into a structural component of the motherboard 4 which supports the electronic components of the motherboard 4. Further, as seen in FIG. 5, the mounting frame 5 similarly comprises a plurality of mounting brackets 51 and a plurality of holes 52, with the plurality of mounting brackets 51 of the mounting frame 5 being perimetrically distributed about the mounting frame 5 and being laterally connected to the mounting frame 5, and each of the plurality of holes 52 of the mounting frame 5 traversing laterally through one of the mounting brackets 51 of the mounting frame 5. Thus, each of the plurality of holes 36 of the display frame 3 are aligned with one of the threaded holes 40 of the motherboard 4 and one of the plurality of holes 52 holes of the mounting frame 5, through all of which a screw or similar fastener may be inserted to affix the display frame 3, the motherboard 4, and the mounting frame 5 together. The plurality of mounting brackets 35 of the display frame 3, the plurality of mounting brackets 51 of the mounting frame 5, and the plurality of threaded holes 40 of the motherboard 4 are configured to be affixed together through a plurality of fasteners.

The mounting frame 5 is a structural element of the present invention that facilitates attachment of the present invention to a motor vehicle in accordance with typical license plate mounting configurations. To this end, the mounting frame 5 comprises a plurality of mounting holes 53, each of which traverse perpendicularly through the mounting frame 5, and are distributed across the mounting frame 5, preferably in a rectangular configuration typical of license plate mounts. In order to install the present invention, the user first screws the mounting frame 5 to the motor vehicle using the mounting holes, then assembles the motherboard 4 and the display frame 3 (with the display screen installed into the recess 34) to align the mounting brackets 51 of the display frame 3, the threaded holes 40 of the motherboard 4, and the mounting brackets 51 of the mounting frame 5, and installs screws or other applicable fasteners into the aligned holes.

The present invention is further accompanied with a method of use. The method of the present invention may be carried out by one or more electronic devices, servers, or other related entities acting individually and/or in combination. The method of the present invention may further be implemented through any applicable electronic communication means, any applicable software programs, applications, code, or programming languages, or any applicable configuration of accounts, databases, or other applicable entities.

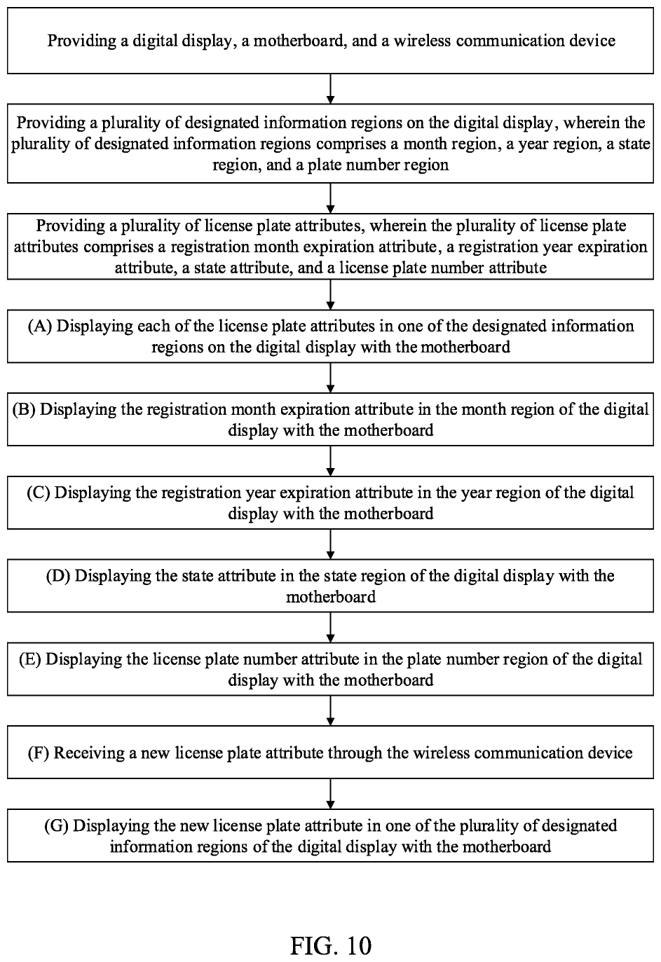

Referring to FIG. 10, in the method of the present invention, the digital display 1, the motherboard 4, and the wireless communication device 6 are provided. In addition, a plurality of designated information regions are provided on the digital display 1, wherein the plurality of designated information regions comprises a month region, a year region, a state region, and a plate number region. Further provided is a plurality of license plate attributes, wherein the plurality of license plate attributes comprises a registration month expiration attribute, a registration year expiration attribute, a state attribute, and a license plate number attribute.

Each of the license plate attributes is displayed in one of the designated information regions on the digital display 1 with the motherboard 4. More particularly, the registration month expiration attribute is displayed in the month region of the digital display 1 with the motherboard 4; the registration year expiration attribute is displayed in the year region of the digital display 1 with the motherboard 4; the state attribute is displayed in the state region of the digital display 1 with the motherboard 4; and the license plate number attribute is displayed in the plate number region of the digital display 1 with the motherboard 4. As one of the primary goals of the present invention, a new license plate attribute may be received by the motherboard 4 through the wireless communication device 6, or through a wired connection as previously discussed. Subsequently, the new license plate attribute is displayed in one of the plurality of designated information regions of the digital display 1 with the motherboard 4. Which designated information region the new license plate attribute is displayed in should correspond with the nature of the new license plate attribute; for example, upon renewing the vehicle's registration, two new license plate attributes are received, corresponding to a new registration month expiration and a new registration year expiration, which are displayed in the month region and the year region, respectively, replacing the previous month and year attributes.

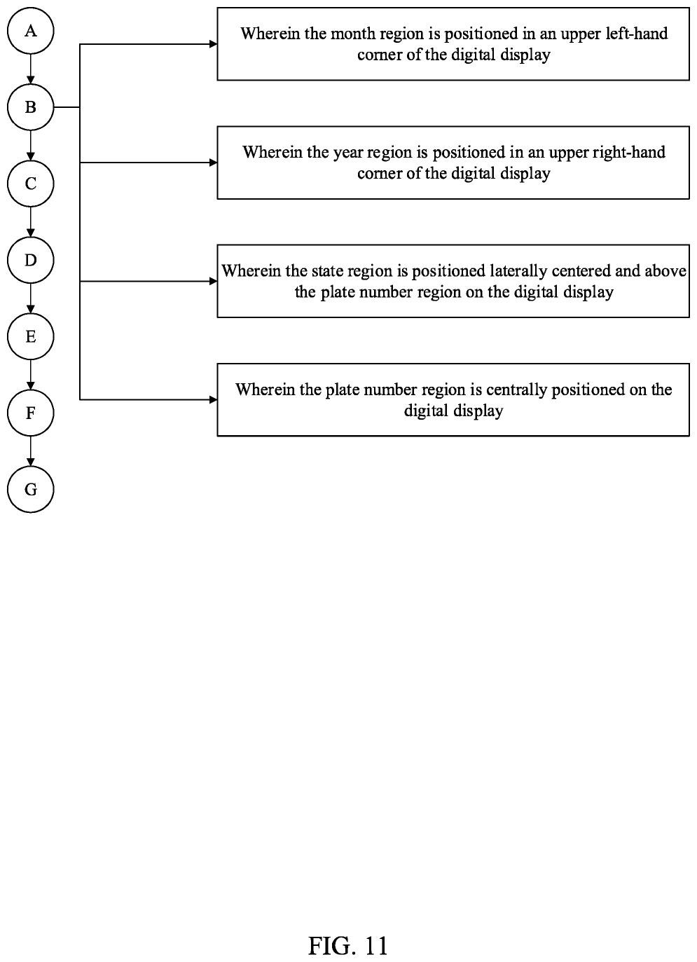

In the preferred embodiment, as described in FIG. 11, the month region is positioned in an upper left-hand corner of the digital display 1, while the year region is positioned in an upper right-hand corner of the digital display 1. The state region is positioned laterally centered and above the plate number region, which is centrally positioned on the digital display 1. The location of the various regions may vary in different embodiments, however.

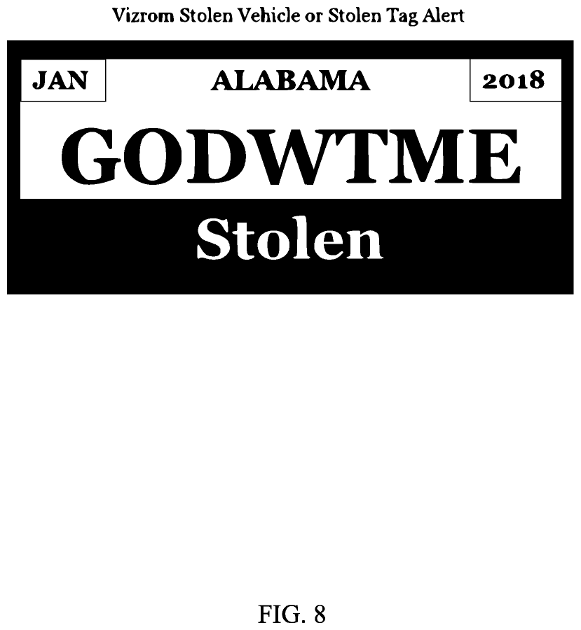

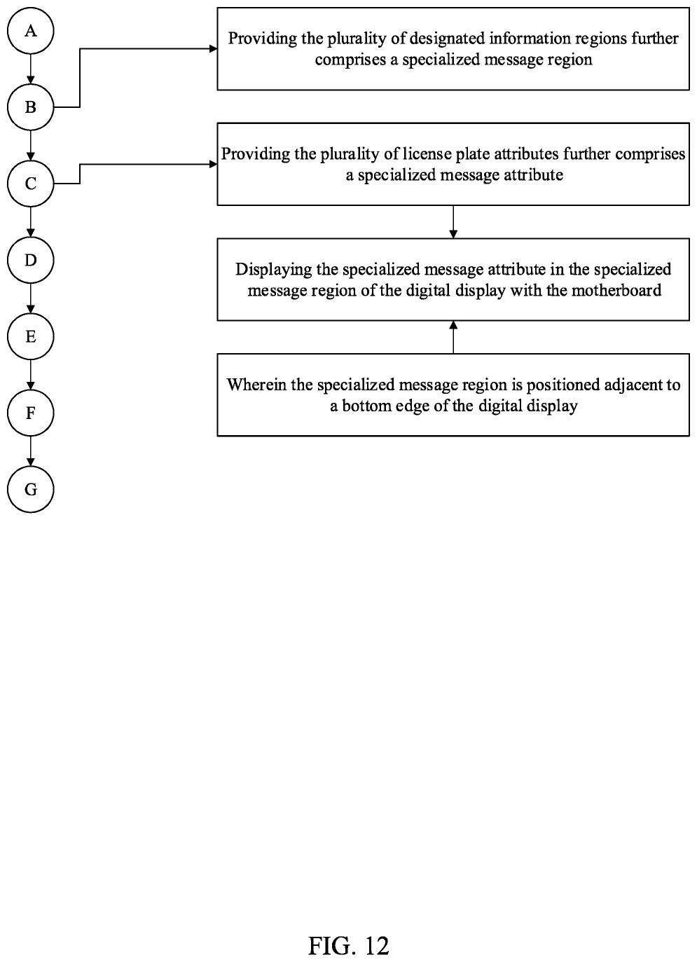

In addition to the aforementioned standard license plate information, the present invention may enable the use of specialized messages, as shown in FIG. 12. To this end, the plurality of designated information regions further comprises a specialized message region, while the plurality of license plate attributes further comprises a specialized message attribute. The specialized message attribute is displayed in the specialized message region of the digital display 1 with the motherboard 4, wherein the specialized message region is positioned adjacent to a bottom edge of the digital display 1. The specialized message region may serve a variety of purposes; for example, the user may display a custom message, or if the vehicle is reported stolen, a “STOLEN” message may be displayed in the specialized message region as illustrated in FIG. 8, or elsewhere on the digital display 1. Alternatively, the user may be allowed to select from a list of pre-approved messages, such as a state motto, a quotation, or a holiday greeting or birthday celebration message.

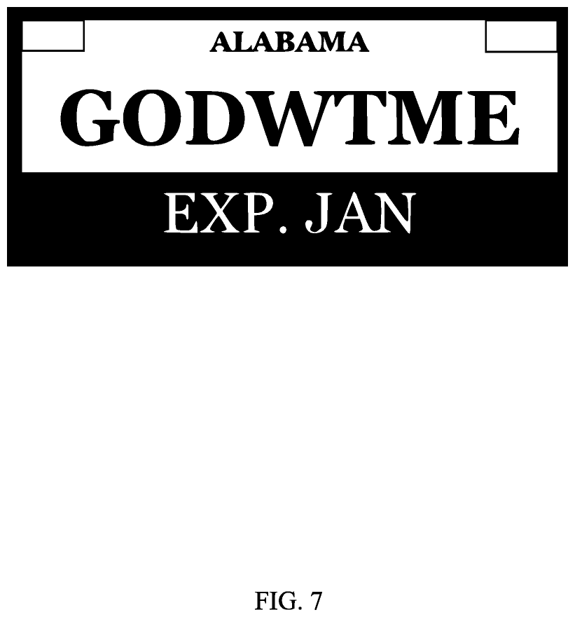

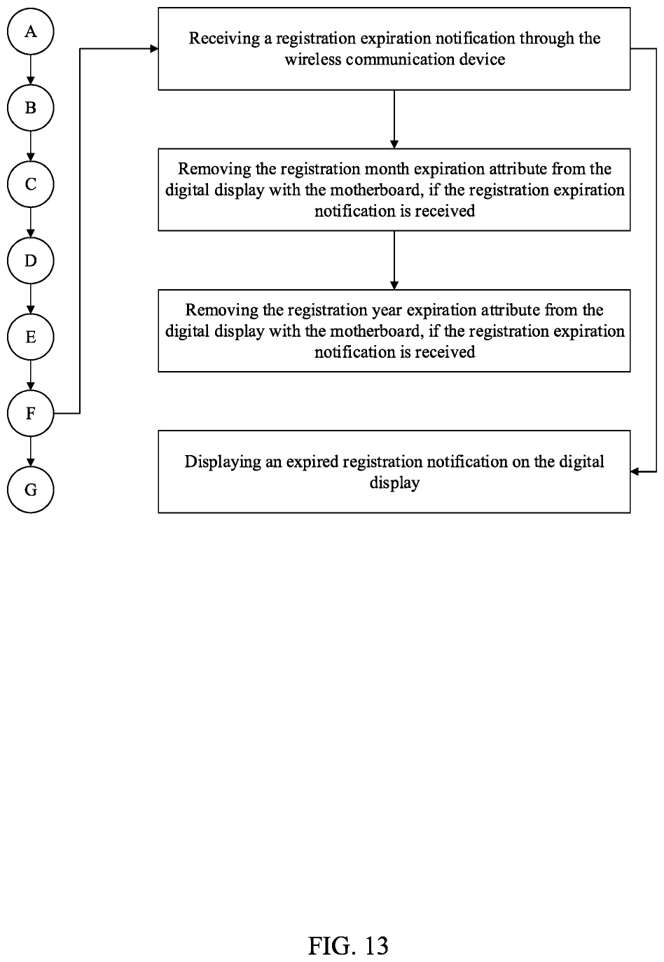

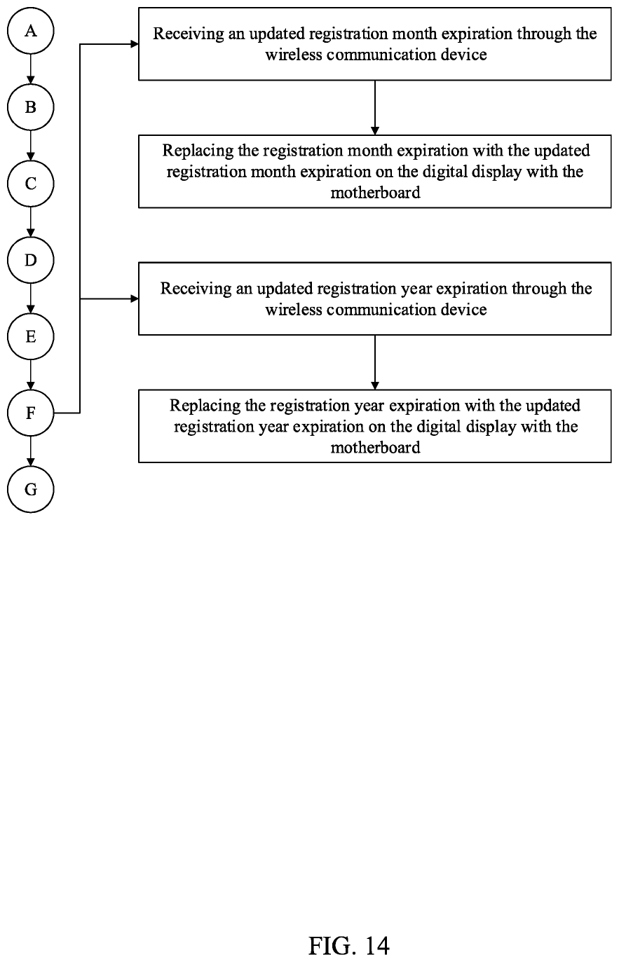

The method of the present invention may enable various additional features. If the vehicle's registration expires, the digital display 1 may automatically change to correspond, as illustrated in FIGS. 13-14. To this end, a registration expiration notification may be received through the wireless communication device 6 with the motherboard 4. The registration month expiration attribute and the registration year attribute may be subsequently removed from the digital display 1 with the motherboard 4, if the registration expiration notification is received. Alternatively, as illustrated in FIG. 7 an expired registration notification may be displayed on the digital display 1 if the registration expiration notification is received, such as, but not limited to, “EXPIRED,” “EXP,” or simply “X,” for example.

In a similar vein, when the user renews their vehicle registration, the present invention may change the digital display 1 to match. To this end, an updated registration month expiration and an updated registration year expiration may be received through the wireless communication device 6. Subsequently, the registration month expiration is replaced with the updated registration month expiration on the digital display 1 with the motherboard 4, and the registration year expiration is replaced with the updated registration year expiration on the digital display 1 with the motherboard 4. Moreover, any region of the digital display 1 may be changed to any desirable and relevant information, as controlled by the motherboard 4. Certain restrictions on the user's control over the digital display 1 may be enabled. For example, the user may not be able to change anything displayed on the digital display 1 without authorization from the department of motor vehicles, or any changes must be made directly by the DMV itself, communicating with the present invention through a remote server, cellular networks, the Internet, or other means.

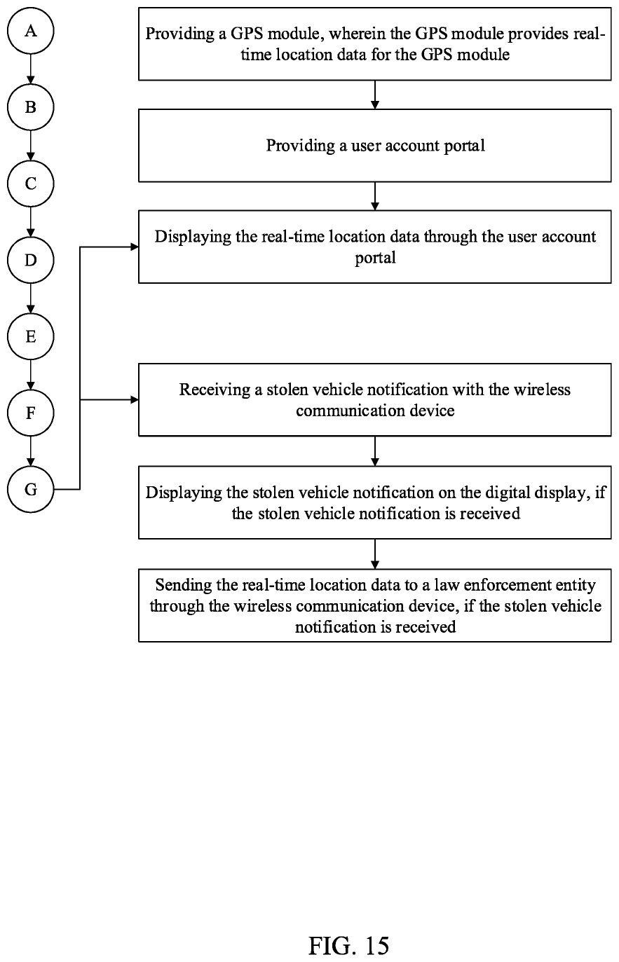

Referring to FIG. 15, a GPS module 80 is further provided in the present invention, wherein the GPS module 80 provides real-time location data for the GPS module 80. This may serve many purposes, and specific implementations may vary in different embodiments. In some embodiments, a user account portal may be provided using a remote server that the user may access through the Internet or through a mobile application on their smartphone or similar device, through which the user may view the location of their vehicle at any time. GPS data may be used in various instances to monitor driving speed and issue citations for exceeding posted speed limits, for example, or for other purposes. The GPS data may also be useful for law enforcement. If the vehicle the present invention is attached to is stolen, various means may be utilized to detect this condition automatically, or the user may report their vehicle as stolen, or the stolen condition may be triggered through other means. Once the stolen condition is received by a remote server in communication with the present invention, the remote server sends a stolen vehicle notification to the present invention, which is received by the motherboard 4 through the wireless communication device 6. Subsequently, the stolen vehicle notification is displayed on the digital display 1, if the stolen vehicle notification is received, and the real-time location data from the GPS module 80 is sent to a law enforcement entity through the wireless communication device 6, if the stolen vehicle notification is received.

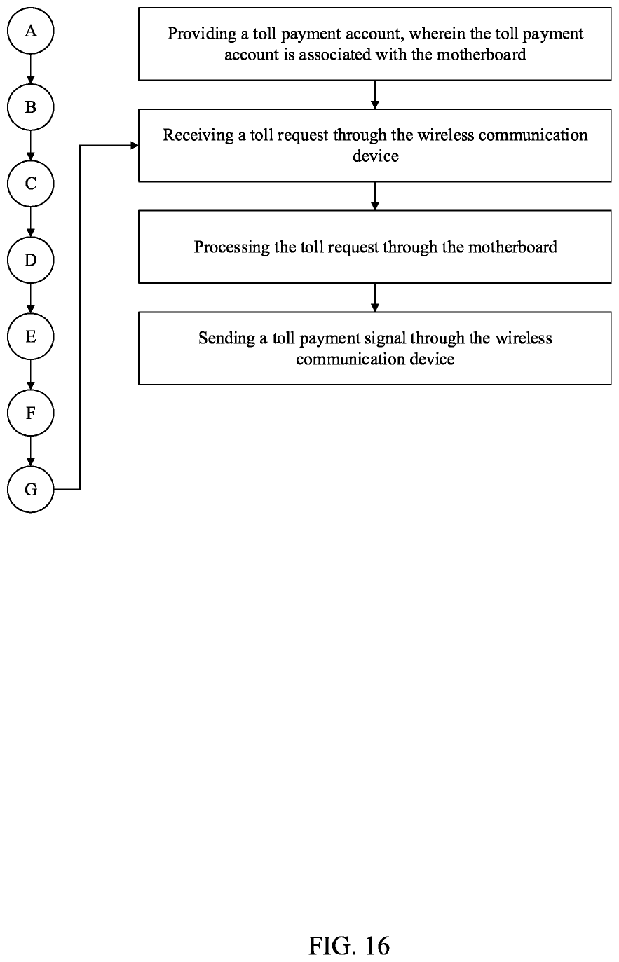

Referring to FIG. 16, the present invention may further facilitate toll payment in some embodiment. To this end, a toll payment account may be provided, to which the user has access and which is associated with the motherboard 4, or other identifying characteristics of the user's instance of the present invention. Upon approaching a toll booth, a toll request may be received through the wireless communication device 6, which is processed by the motherboard 4, and a toll payment signal is sent through the wireless communication device 6. In various embodiment, the toll payment feature may function in various ways and implementations. Generally speaking, the motherboard 4 may communicate with a toll booth through the wireless communication device 6 in order to initiate or complete payment of a toll.

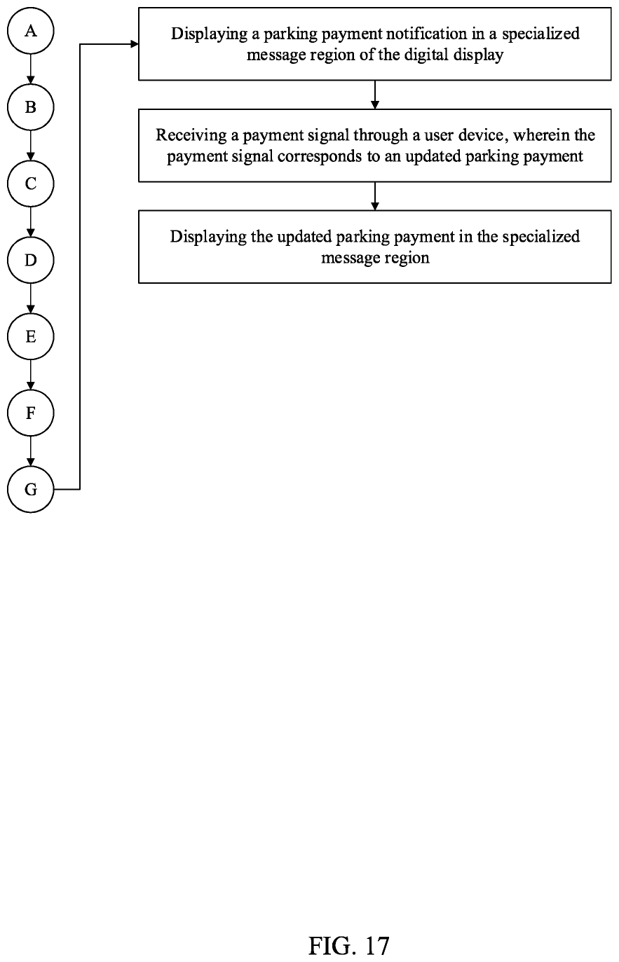

Referring to FIG. 17, another feature the present invention may enable is a parking payment and/or validation feature. In some embodiments, a parking payment notification may be displayed in the specialized message region of the digital display 1. A payment signal may be received through a user device, wherein the payment signal corresponds to an updated parking payment, and the updated parking payment information may be displayed in the specialized message region. Specific implementation of this feature may vary in different embodiments. For example, the user may interact with a mobile application on their smartphone in order to pay for a parking spot. The user may further have an option to add time if the previously paid for time is close to expiring and the user does not believe they will be moving their vehicle soon.

It is contemplated that various other features may be enabled by the present invention, such as, but not limited to, vehicle-to-vehicle communication, vehicle-to-everything technology, data collection, statistical analysis, or any other applicable features.

Although the invention has been explained in relation to its preferred embodiment, it is to be understood that many other possible modifications and variations can be made without departing from the spirit and scope of the invention as hereinafter claimed.

What is claimed is:

1. An electronic license plate comprises:
a digital display;
a protective layer;
a display frame;
a motherboard;
a mounting frame;
a wireless communication device;
a power source;
the protective layer, the digital display, the display frame, the motherboard, and the mounting frame being oriented parallel to each other;
the protective layer being affixed to the digital display;
the digital display being positioned between and layered adjacent to the protective layer and the display frame;
the display frame being positioned between and layered adjacent to the digital display and the motherboard;
the motherboard being positioned between and layered adjacent to the display frame and the mounting frame;
the motherboard being electronically connected to the digital display and the wireless communication device; and
the power source being electrically connected to the digital display and the wireless communication device.

2. The electronic license plate as claimed in claim 1 comprises:
the protective layer being a protective glass layer.

3. The electronic license plate as claimed in claim 1 comprises:
the protective layer being transparent.

4. The electronic license plate as claimed in claim 1 comprises:
the digital display being an electronic paper display (EPD).

5. The electronic license plate as claimed in claim 1 comprises:
a location module;
the location module being electronically connected to the motherboard.

6. The electronic license plate as claimed in claim 5 comprises:
the location module being a global positioning system (GPS) module.

7. The electronic license plate as claimed in claim 1 comprises:
the display frame comprises front side, a back side, a perimeter and a recess;
the recess being positioned within the perimeter;
the recess traversing into the front side; and
the digital display being positioned within the recess of the display frame.

8. The electronic license plate as claimed in claim 1 comprises:
the display frame comprises a plurality of mounting brackets and a plurality of holes;
each of the plurality of mounting brackets being laterally connected to a perimeter of the display frame;
each of the plurality of holes laterally traversing through one of the plurality of mounting brackets;
the motherboard comprises a plurality of threaded holes;
each of the plurality of threaded holes laterally traversing into the motherboard;
the mounting frame comprises a plurality of mounting brackets and a plurality of holes;
the plurality of mounting brackets of the mounting frame being perimetrically distributed about the mounting frame;
each of the plurality of mounting brackets of the mounting frame being laterally connected to the mounting frame;
each of the plurality of holes of the mounting frame traversing laterally through one of the plurality of mounting brackets of the mounting frame; and
each of the holes of the display frame being aligned with one of the threaded holes of the motherboard and one of the holes of the mounting frame.

9. The electronic license plate as claimed in claim 8 comprises:
the plurality of mounting brackets of the display frame, the plurality of mounting brackets of the mounting frame, and the plurality of threaded holes being configured to be affixed together through a plurality of fasteners.

10. The electronic license plate as claimed in claim 1 comprises:
the mounting frame comprises a plurality of mounting holes;
each of the plurality of mounting holes perpendicularly traversing through the mounting frame; and
the plurality of mounting holes being distributed across the mounting frame.

11. A method of using an electronic license plate comprises the steps of:
providing a digital display, a motherboard, and a wireless communication device;
providing a plurality of designated information regions on the digital display, wherein the plurality of designated information regions comprises a month region, a year region, a state region, and a plate number region;
providing a plurality of license plate attributes, wherein the plurality of license plate attributes comprises a registration month expiration attribute, a registration year expiration attribute, a state attribute, and a license plate number attribute;
displaying each of the license plate attributes in one of the designated information regions on the digital display with the motherboard;
displaying the registration month expiration attribute in the month region of the digital display with the motherboard;
displaying the registration year expiration attribute in the year region of the digital display with the motherboard;
displaying the state attribute in the state region of the digital display with the motherboard;
displaying the license plate number attribute in the plate number region of the digital display with the motherboard;
receiving a new license plate attribute through the wireless communication device; and
displaying the new license plate attribute in one of the plurality of designated information regions of the digital display with the motherboard.

12. The method of using an electronic license plate as claimed in claim 11,
wherein the month region is positioned in an upper left-hand corner of the digital display;
wherein the year region is positioned in an upper right-hand corner of the digital display;
wherein the state region is positioned laterally centered and above the plate number region on the digital display; and
wherein the plate number region is centrally positioned on the digital display.

13. The method of using an electronic license plate as claimed in claim 11 comprises the steps of:
providing the plurality of designated information regions further comprises a specialized message region;
providing the plurality of license plate attributes further comprises a specialized message attribute; and
displaying the specialized message attribute in the specialized message region of the digital display with the motherboard,
wherein the specialized message region is positioned adjacent to a bottom edge of the digital display.

14. The method of using an electronic license plate as claimed in claim 11 comprises the steps of:
receiving a registration expiration notification through the wireless communication device;
removing the registration month expiration attribute from the digital display with the motherboard, if the registration expiration notification is received; and
removing the registration year expiration attribute from the digital display with the motherboard, if the registration expiration notification is received.

15. The method of using an electronic license plate as claimed in claim 11 comprises the steps of:
receiving a registration expiration notification through the wireless communication device; and
displaying an expired registration notification on the digital display.

16. The method of using an electronic license plate as claimed in claim 11 comprises the steps of:
receiving an updated registration month expiration through the wireless communication device;
receiving an updated registration year expiration through the wireless communication device;
replacing the registration month expiration with the updated registration month expiration on the digital display with the motherboard; and
replacing the registration year expiration with the updated registration year expiration on the digital display with the motherboard.

17. The method of using an electronic license plate as claimed in claim 11 comprises the steps of:
providing a GPS module, wherein the GPS module provides real-time location data for the GPS module;
providing a user account portal; and
displaying the real-time location data through the user account portal.

18. The method of using an electronic license plate as claimed in claim 11 comprises the steps of:
providing a GPS module, wherein the GPS module provides real-time location data for the GPS module;
receiving a stolen vehicle notification with the wireless communication device;
displaying the stolen vehicle notification on the digital display, if the stolen vehicle notification is received; and
sending the real-time location data to a law enforcement entity through the wireless communication device, if the stolen vehicle notification is received.

19. The method of using an electronic license plate as claimed in claim 11 comprises the steps of:
providing a toll payment account, wherein the toll payment account is associated with the motherboard;
receiving a toll request through the wireless communication device;
processing the toll request through the motherboard; and
sending a toll payment signal through the wireless communication device.

20. The method of using an electronic license plate as claimed in claim 11 comprises the steps of:
displaying a parking payment notification in a specialized message region of the digital display;
receiving a payment signal through a user device, wherein the payment signal corresponds to an updated parking payment; and
displaying the updated parking payment in the specialized message region.
